(19) United States
(12) Patent Application Publication
(10) Pub. No.: US 2006/0204134 A1
(43) Pub. Date: Sep. 14, 2006

(54) Method and system of viewing digitized roll film images

(76) Inventors: James Modrall, Pleasanton, CA (US); Brian Porter, San Francisco, CA (US); Bruce Zeuli, Benicia, CA (US)

Correspondence Address: Sean M. Fitzgerald, 3182 Campus Drive #342, San Mateo, CA, 94403-3123, US

(21) Appl. No.: 11/091,351

(22) Filed: Mar. 27, 2005

Related U.S. Application Data
(63) Continuation-in-part of application No. 11/070,857, filed on Mar. 1, 2005.

(51) Int. Cl. G06K 9/00; G06K 9/36

(52) U.S. Cl. 382/291; 382/103

(57) ABSTRACT

One example embodiment provides a method and system presenting digital images files output from a roll scanner in a roll format. A viewer receives a meta-data file including orientation, positioning, presentation and/or identification information of image objects and associated image files. Presentation, orientation, and/or identification information is extracted from the meta-data file and loaded into the viewer, which presents the image objects in accordance with the extracted settings and presentation information.

### RELATED APPLICATIONS

The present application is a continuation in part of U.S. patent application Ser. No. 11/070,857 entitled “Method and System of Converting Film Images to Digital Format for Viewing” filed Mar. 1, 2005.

### BACKGROUND

1. Field of the Invention

The field of the invention relates generally to systems for converting hard copy images to digital files for viewing and storage.

2. Related Background

Storage and viewing of historical documents has always been a cumbersome task. Documents stored in book form were prone to damage and loss. Conversion of paper records to microfilm or microfiche reduced warehousing and storage costs, and were generally less prone to damage and loss than paper. However, microfilm and microfiche are not immune from damage, and copying and storing duplicate copies is both time consuming and costly. Additionally, locating a particular document or page of a document in a microfilm or microfiche record can be cumbersome and time consuming task. Often, a person searching a record may only view the microfilm or microfiche with a special viewing machine, typically only available in a library or records office, and with limited access. Actually locating the desired document or page often requires scrolling through considerable numbers of documents or pages.

Systems exist to convert microfilm or microfiche images to digital format. One example of such a system is the RS300 Scanstation microfilm scanner made by Wicks and Wilson® which can take digital photographs of roll film such as microfilm and outputs a digital file for each snapshot taken. Other general purpose and specialized systems exist which may convert roll film into a digital image.

Accordingly, the present invention seeks to overcome the limitations of prior document storage and viewing systems.

### BRIEF DESCRIPTION OF THE FIGURES

FIG. 1 is a generalized block diagram of a computer system that may be used to implement the present invention, according to one embodiment of the invention.

FIG. 2 is a generalized block diagram of a software architecture that may be used to implement the present invention, according to one embodiment of the invention.

FIG. 3 is a generalized block diagram of a computer system that may be used to implement the present invention, according to one embodiment of the invention.

FIG. 4 is a generalized block diagram of images from a reel scanner illustrating the orientation of the images, according to one embodiment of the invention.

FIG. 5 is a generalized flow diagram illustrating a process of creating meta data files for viewing the digital image files of the roll image, according to one alterative embodiment of the invention.

FIG. 6 is a generalized block diagram illustrating the output files of the process of creating image viewing meta-data files, according to one embodiment of the invention.

FIG. 7 is a generalized flow diagram illustrating the process of preparing the digital image files output from the reel scanner for viewing by a viewer, according to one embodiment of the invention.

FIG. 8 is a generalized block diagram illustrating a digital reel viewer, according to one embodiment of the present invention.

FIG. 9 is a generalized flow diagram illustrating the process of presenting a reel image including image objects, according to one embodiment of the present invention.

FIG. 10 is a generalized flow diagram illustrating an alternate embodiment of the process of presenting a reel image including image objects.

FIG. 11 is a generalized block diagram illustrating an alternate embodiment of a digital reel viewer.

FIG. 12 is a generalized flow diagram illustrating the process of navigating between, and presenting, image objects in a reel image, according to one embodiment of the present invention.

FIG. 13 is a generalized flow diagram illustrating the process of responding to change image object instructions from the jump controls of the viewer, according to one embodiment of the present invention.

FIG. 14 is a generalized flow diagram illustrating the process of establishing bookmarks in the digitized roll film, according to one embodiment of the present invention.

### SUMMARY

The present invention provides a system and method of converting hard copy images to a digital format for storage and viewing. To allow viewing of a group of images in a scrolling format, an image interpretation file is created for use by a viewer. In one example embodiment, the digital images of a roll film are presented in a viewer in the proper sequence, allowing the viewer to present the image objects in the proper sequence, and allow the image objects to be navigated by scrolling through the sequence in a manner similar to scrolling through the original roll film. The viewer receives presentation and configuration information from the image interpretation file. Both image object and digital image sequence information are obtained from the image interpretation file, as well as information identifying aspects of the image objects, such as the name, title, volume, book or frame. Navigation of the image objects may be accomplished by jumping directly to a given image object by entering identifying information (such as volume and frame number), which the viewer process with information retrieved from the image interpretation file to retrieve and present the image file with the image object corresponding to the entered information. Navigation may also be performed by scrolling, where the viewer determines the next image file to present according to information retrieved from the image interpretation file, and presents the image files and image objects in a manner that gives the look of scrolling through roll film. Navigation may also be performed by jumping a set number of image objects (or other increments) in the sequence. The viewer retrieves sequence information from the image interpretation file, determines the proper image file and image object to present, retrieves the image file corresponding to the number of jumped imaged objects.

### DETAILED DESCRIPTION

The present invention is described in the context of a specific embodiment. This is done to facilitate the understanding of the features and principles of the present invention and the present invention is not limited to this embodiment. In particular, the present invention is described in the context of a system for converting documents stored on rolls of microfilm to a digital format for viewing and storage. The present invention is applicable to other systems for viewing, storing and retrieving documents and images.

The example embodiment provides for a system and method of converting roll film to digital images. As used in the present application, the term roll film is used to include all types of roll images, whether microfilm, microfiche, 35 mm film, other formats of photographic film, or other types of roll images on film, paper or other medium. As used in the present invention, roll images is used to include any image having one dimension much greater than another dimension, one example of which is a roll of film which, when unspooled, extends to a length much greater than the width of the film. As with a roll of film, a roll image may include multiple individual images, as with a roll of 35 mm photographic film, or may include only one extended image.

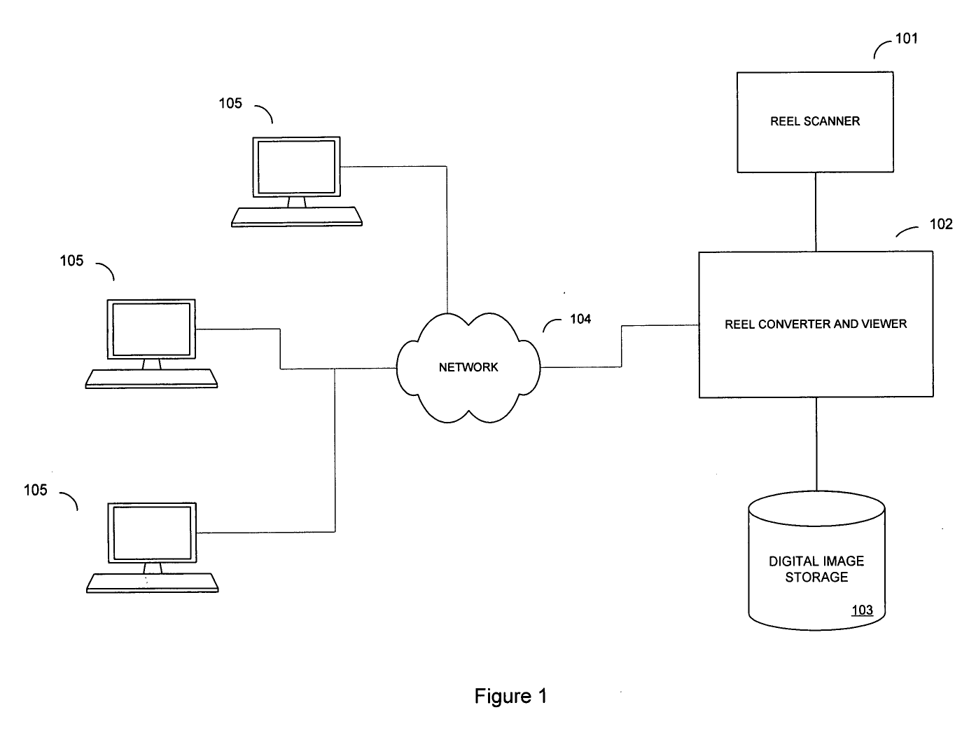

FIG. 1 is a block diagram of a computer system 100 that may be used to implement embodiments of the present invention. A reel scanner 101 is connected to a reel converter and viewer server 102. The reel converter and viewer server 102 is connected to a digital image storage repository 103 and communications network 104. End-user communication devices 105 are connected to the digital image repository through the communications network 104. The end-user communications devices may be used to view digital images processed by the present invention with a viewer described below. The content servers are the servers used to manage content which end-users wish to access.

One example of a reel scanner is the RS300 Scanstation microfilm scanner made by Wicks and Wilson®. The RS300 microfilm scanner can take digital photographs of roll film such as microfilm and outputs a digital file for each snapshot taken. The snapshot taken represents a single portion of the roll of microfilm. Typically, this single portion represents a few inches of the roll of microfilm. To digitally record an entire roll of microfilm, it is typically necessary to take multiple snapshots of the different segments of the roll of microfilm. Accordingly, the output from a scanner like the RS300 is a series of digital files representing digital images of segments of the roll of microfilm.

While the presently preferred embodiment utilizes a specialized device for scanning roll film images, alternate embodiments of the present invention could use either specialized scanners or general purpose scanners. For example, the present application could be used with general purpose scanners used in scanning images into a format readable by a personal computer. Other examples of general purpose scanners include digital copiers.

In the presently preferred embodiment, the end-user viewing device is a personal computer. Additionally, in the presently preferred embodiment the communications network is the Internet. Connection to the Internet could be by any form of Internet connection, including broadband and wireless connection. Alternatively, a private network or direct link could be established between the reel converter and viewer server and the viewing device. Alternatively, the end user communications device could be a mobile phone (including web enabled mobile phones or mobile phones with text messaging capabilities), standard telephone, PDA or any other device capable of receiving text or voice messages.

The reel converter and viewer server could be implemented on one single server or on multiple servers. Similarly, the digital image storage server could be implemented on one single server or on multiple servers, or could be combined on the same computer as the reel converter and viewer server. Actual storage of the digital images and assorted files could be in the memory of the digital image storage server, on the hard drive of the digital image storage server, on hard drives of a storage device communicatively connected to the digital image storage server, or on other media of storage such as magnetic tape, optical storage, etc. As used in the present application, the term server may refer to a physical computer or to software performing the functions of a server.

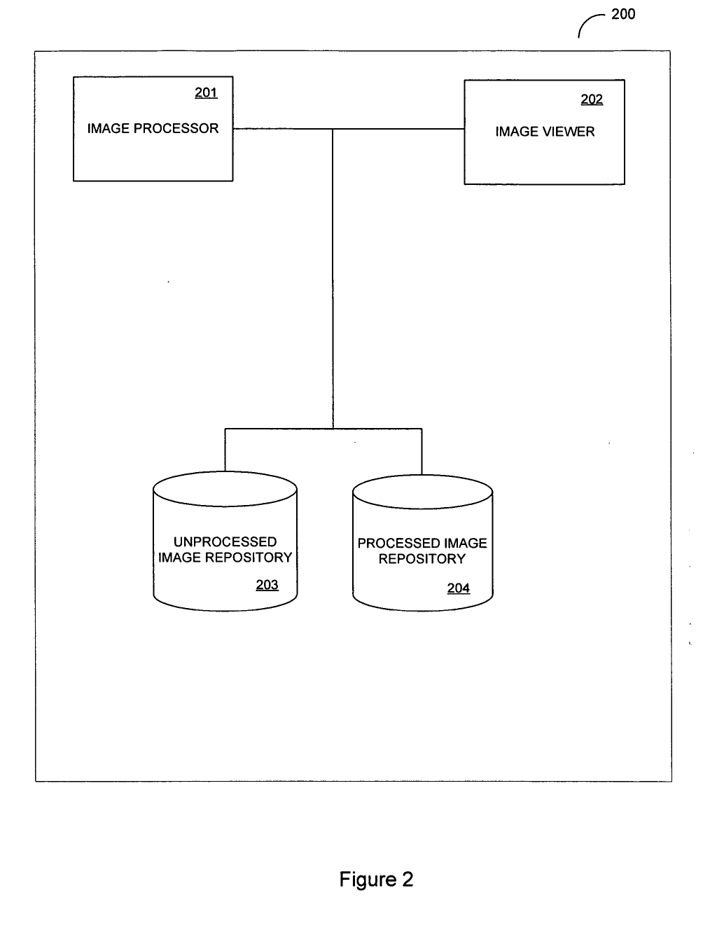

FIG. 2 is a generalized block diagram of the reel converter and viewer server shown in FIG. 1. The reel converter and viewer server 200 includes an image processor 201 for processing the image segments received from the reel scanner into a format viewable as a roll image. Images received from the reel scanner are stored in an unprocessed image repository 203. Images processed by the image processor 201 to a format viewable as a roll image are stored in the processed image repository 204. A digital reel viewer 202 allows processed images to be viewed in roll form by an end user accessing the reel converter and viewer server.

In the presently preferred embodiment, the digital reel image viewer is a separate software program. In one embodiment of the present invention the digital reel image viewer is installed on an end user communications device such as a PC. Typically, in such an implementation, the end user would not have access, via the digital reel image viewer, to the unprocessed digital images (although alternate embodiments may provide such access). The processed image repository may be located on the end-user communications device, on a storage medium accessible by the end-user communications device, or accessible by the end-user communications device over a communications network. Alternate embodiments of the present invention could use a client-server implementation to view images on a client installed on the end-user communications device, including, for example, a web browser capable of accessing and displaying digital reel images from a digital reel image web server.

While the presently preferred embodiment utilizes both the unprocessed image repository and the processed image repository on the same host computer as the image processor and the digital reel viewer, alternate embodiments of the present invention could utilize any or all of these components on different host computers. Additionally, any or all of the components of the reel converter and viewer server may be split among several host computers in alternate embodiments of the present invention.

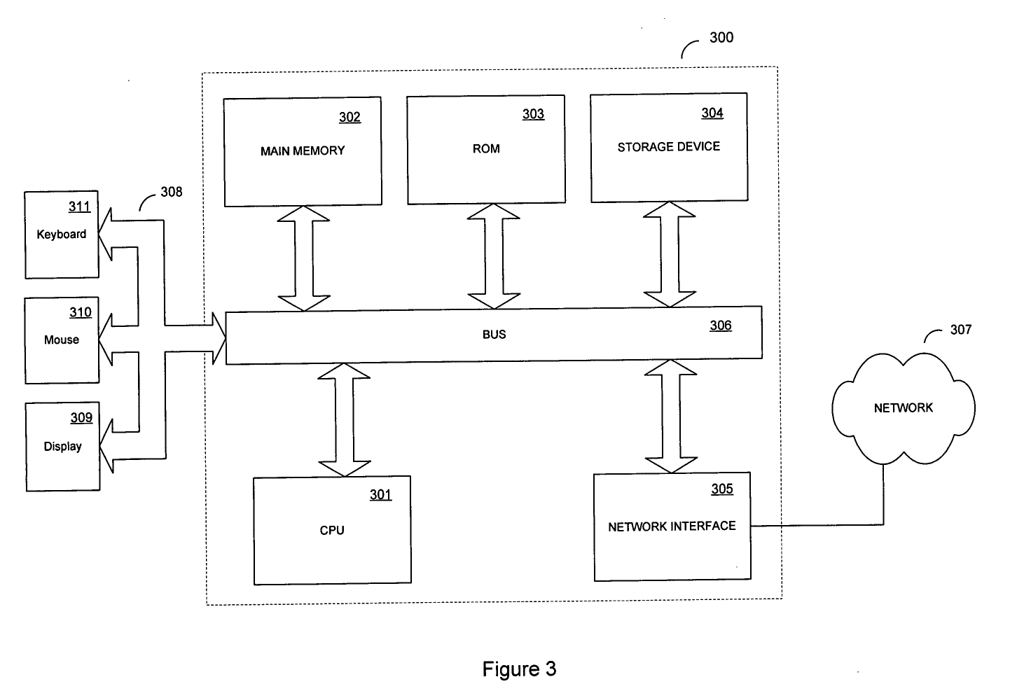

FIG. 3 is a generalized block diagram of a reel converter and viewer server computer 300 including a central processing unit (CPU) 301, main memory (typically RAM) 302, read-only memory (ROM) 303, a storage device (typically a hard drive) 304, and a network device (typically a network interface card, a.k.a. NIC) 305. The network device connects to a communications network 307. The server includes a bus 306 or other communication mechanism for communicating information between the CPU 301 coupled with bus 306. The CPU 301 is used for processing instructions and data. The main memory 302, ROM 303 and storage device 304 are coupled to bus 306 and store information and instructions to be executed by processor 301. Main memory 302 also may be used for storing temporary variables or other intermediate information during execution of instructions to be executed by processor 301.

Server 300 may be coupled via bus 308 to a display 309, such as a cathode ray tube (CRT) or flat panel monitor, for displaying information to a computer user. An input device 310, such as a keyboard, is coupled to bus 308 for entering information and instructions to the server 300. Additionally, a user input device 311 such as a mouse, a trackball, or cursor direction keys for communicating direction information and command selections to the processor 301 and for controlling cursor movement on the display 309 may be used with the server 300.

The server 300 is designed to run programs implementing methods, such as the methods of the present invention. Typically such programs are stored on the hard drive of the server, and instructions and data of the program are loaded into the RAM during operation of the program. Alternate embodiments of the present invention could have the program loaded into ROM memory, loaded exclusively into RAM memory, or could be hard wired as part of the design of the server. Accordingly, programs implementing the methods of the present invention could be stored on any computer readable medium coupled to the server. The present invention is not limited to any specific combination of hardware circuitry and software, and embodiments of the present invention may be implemented on many different combinations of hardware and software.

As used within the present application, the term “computer-readable medium” refers to any medium that participates in providing instructions to CPU 301 for execution. Such a medium may take many forms including, but not limited to, non-volatile media, volatile media, and transmission media. Examples of non-volatile media include, for example, optical or magnetic disks, such as storage device 304. Examples of volatile media include dynamic memory, such as main memory 302. Additional examples of computer-readable media include, for example, floppy disks, hard drive disks, magnetic tape, or any other magnetic medium, a CD-ROM, any other optical medium, punchcards or any other physical medium with patterns of holes, a RAM, a PROM, and EPROM, a FLASH-EPROM, any other memory chip, stick or cartridge, a carrier wave as described hereinafter, or any other medium from which a computer can read. Transmission media includes coaxial cables, copper wire and fiber optics, including the wires that comprise bus 306 and 308. Transmission media can also take the form of acoustic, electromagnetic or light waves, such as those generated during radio-wave and infra-red data communications.

The end user viewing device is similar in general architecture to the reel converter and viewer server.

### EDGE DETECTION AND IMAGE ORIENTATION

The present invention provides a method of converting image files output from a scanner to a viewable representation of the original roll of film. As scanners typically only take an image of a portion of the roll of film and output that as an image file, viewing these digital images in a manner which presents the images such that they faithfully represent the actual positioning and orientation of the images in relation to the roll film they were taken from.

The digital images output from the scanner may or may not include an object in the digital image. As used in the present application, an image object is any recognizable content recorded on the roll film. As an example, in the case of county records stored on microfilm, the image object is the page of the county records file (or book). Any type of document recorded on roll film may be an image object. Other examples of image objects include photographs, pictures or artwork, and the like.

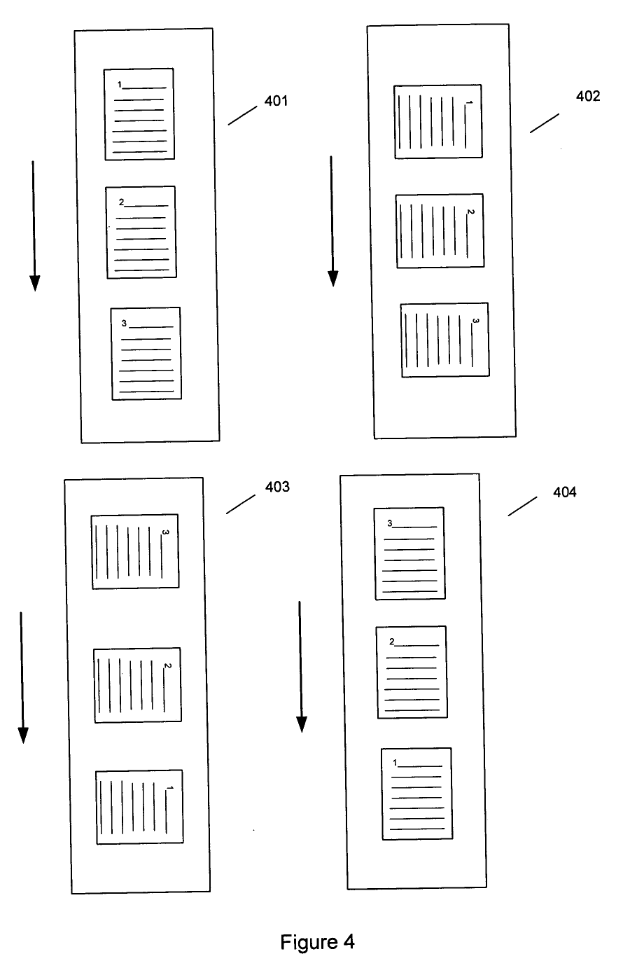

FIG. 4 is a generalized block diagram of images from a reel scanner illustrating the orientation of the images according to one embodiment of the invention. Each image 401 is a segment, or slice, of the roll of film fed into the scanner. In the presently preferred embodiment, the roll film is scanned in its entirety, creating a complete digital record of the roll film.

The individual images of a roll film are typically filmed in one of four possible orientations. The images may be oriented top to bottom as shown in 401, bottom to top (typically referred to as “CineMode”) as shown in 404, left to right as shown in 402, or right to left (typically referred to as “Comic Mode”) as shown in 403. (The directional arrow next to each roll film segment indicates the direction of the roll film pointing from the top, or beginning, of the roll to the bottom, or end, of the roll.) In creating a digital image of the roll film the original orientation of the filming of the roll and the orientation the operator of the reel scanner feeds the roll into the reel scanner determine the orientation of the digital output. In the presently preferred embodiment, the operator of the process of converting the digital image files to a digital reel image enters the orientation of the individual images into the system, as described below.

The individual images of a roll film are “merged” by the present invention to form a “continuous” digital roll. To merge the individual images to form a “continuous” digital roll the present invention creates a metadata file which contains information a viewer running on a computer uses to allow a person to scan through the “continuous” digital roll in much the same way they could view a roll film with a conventional viewer (such as a microfilm viewer). Thus, in this manner the present invention allows a viewer running on a computer to accurately emulate the directional and informational aspects of viewing images by a conventional roll film viewer, using the individual digital images and the associated meta-data file.

### CREATING A DIGITAL IMAGE ORIENTATION FILE

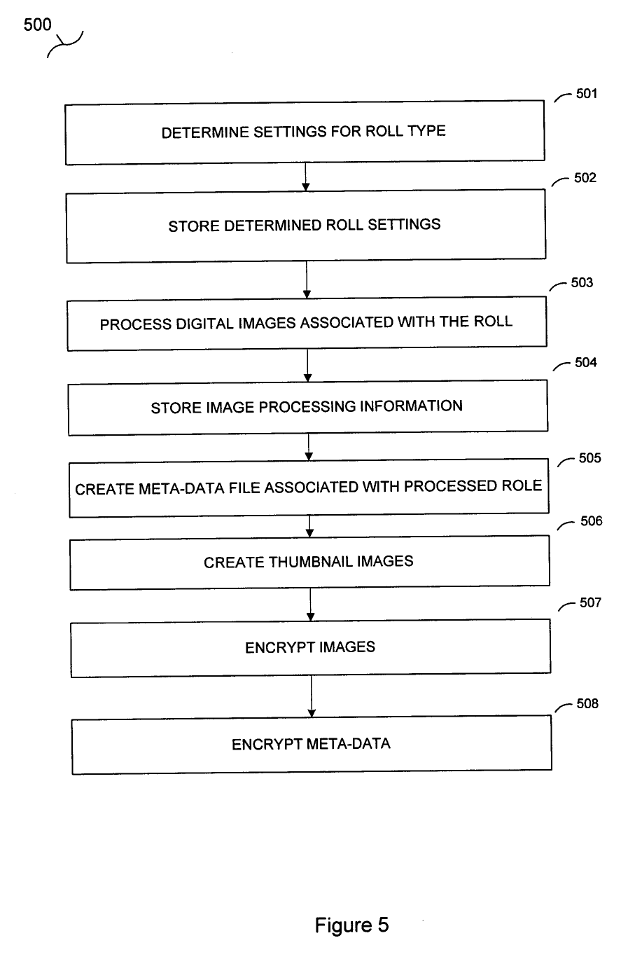

FIG. 5 is a generalized flow diagram illustrating the process 500 of creating a meta-data image interpretation file for viewing the digital image files of the roll image. At step 501 the system determines the settings for the type of roll film. The settings may be entered by an operator of the image processing system, may be received from the image processor, or may be determined by a process of the present invention. Depending upon the implementation of the present invention, the example settings may include relative image orientation (both image order information and image position information), parameters specifying image object orientation, position, location or direction, image content or identifying information, roll film content or identifying information, number of images associated with a roll, minimum image size, image resizing information (either reduction or enlargement), noise correction settings information, encryption or security information, and image pixel information (number of pixels, size of pixels, pixel correction or alteration information, white page on a black background, white page with a border on a black background, a page in a fixed position on each fame, etc.).

At step 502 the system stores the roll settings. Preferably, the roll type settings information is stored in an XML file for later use, but may be stored in any format and in either storage or memory for use with the processing of the digital images of the roll film. The present invention also allows roll type settings to be stored and associated with multiple groups of images, corresponding to processing multiple rolls of film, as for example with batch processing of roll film. The present invention may store all of the roll settings from step 501, or a subset of the roll settings from step 501.

At step 503 the system processes the digital images of the roll film according to the settings for the roll type determined in step 501. The processing of the digital images may include resizing of the images (the resizing may be temporary to aid in processing), merger of multiple images into a singe image file (for example, grouping three digital images into a singe digital image file), separation (or partition) of image files into multiple image files (for example, to “Crop” detected objects into separate image files), compression of image file, noise or error correction of image files, truncation or reshaping of image files, location of object(s) in image files (for example, location of pages on digital images of roll microfilm), reorient images (for example, rotate, reverse, or re-order images), sort objects (sort objects according to order or direction information), merge intersecting objects, remove border or edge objects (for example, a barely legible portion of a page intruding into the digital image of another page may be removed or altered), and creation of a list of images, objects, and processing actions taken. The output of step 503 may alter the digital image files, create new digital image files for use in an image viewer, or both. Additionally, the output of step 503 may render the post processing digital image files unchanged, while outputting the information obtained from processing copies (or other representations) of the digital image files.

Note, alternate embodiments of the present invention could allow for improvement of the digital images (that is, defect correction or removal), to aid in viewing, or could specifically prevent improvement, as for example where preservation of exact images of roll film is desired. In embodiments which do not alter the digital images output for viewing, the digital images may be altered as part of the process of creating the image interpretation file (for example, to aid in the location of objects).

After processing the digital images in step 503, the system stores the information received from the processing at step 504.

At step 505 the system creates the meta-data image interpretation files associated with the processed digital images. In the presently preferred embodiment meta-data image interpretation files is an XML file, with tags specifying the use or type of data stored in the meta-data image interpretation file. However, alternate embodiments could use other formats for storing or organizing the information in the meta-data image interpretation file.

The meta-data image interpretation files include information associating on the associated digital images and other meta data which allows the image viewer to present the digital images as a roll film, as well as present other meta-data which a person using the image viewer may find helpful in locating and viewing objects (such as pages from a microfilm or microfiche). Examples of meta-data information that may be included in the meta-data interpretation file include: roll identification information, roll content information, image file identification information, image file content information, image object identification information, image object content information, resizing information, merger information, separation information, compression information, noise or error correction information, truncation or reshaping of image files information, location of object(s) in image files information, roll index information (such as the location of books, or the starting page of an object, within a roll), reoriented images information, sorted objects information, merge intersecting objects, removed border information, and information specifying the number of images, objects, and processing actions taken. Additionally, the meta-data interpretation file may include further security or encryption information, as well as file name or location information specifying the location of the digital images on a storage medium or computer system or network.

In the presently preferred embodiment the system creates thumbnail images at step 506. The thumbnail size images are scaled down version of the digital images associated with the meta-data interpretation file. These thumbnail images may be used for navigation or other purposes by persons using the image viewer to view the digital images of the roll film. While the presently preferred embodiment generates thumbnail images for inclusion with the meta-data interpretation file and digital images, alternate embodiments could do without thumbnail images.

At step 507 the system encrypts the digital images (and optional the thumbnail images) for security purposes. At step 508 the meta-data interpretation file is encrypted for security purposes. Meta-data relating to the encryption of ether the digital images or the meta-data interpretation file may be included in the meta-data interpretation file at the time of its creation, at step 505, or during the encryption.

### OUTPUT FILES FROM IMAGE PROCESSING

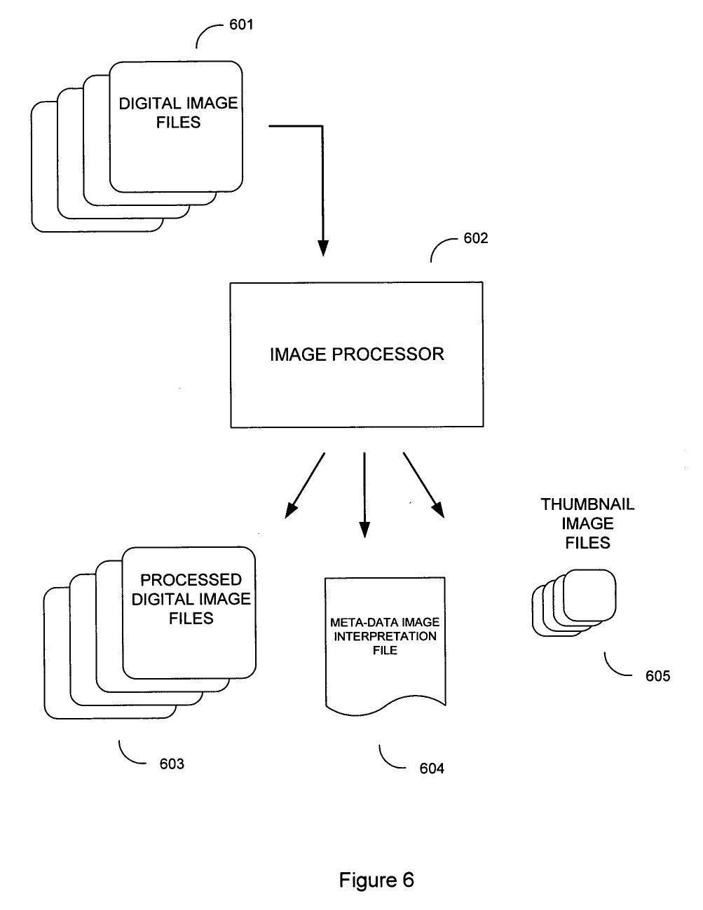

FIG. 6 is a generalized block diagram illustrating the output from the process of creating a meta-data image interpretation file for viewing the digital image files of the roll image, described above in connection with FIG. 5. The reel converter and viewer server 602 runs the process 500 for creating a meta-data image interpretation file. The input for the process of creating a meta-data image interpretation file are the digital image files 601 which are output from the reel scanner (based upon the roll type configuration settings). In the presently preferred embodiment, the process 500 has three outputs, the processed digital images 603, the meta-data image interpretation file 604, and the thumbnail images 605.

While the presently preferred embedment outputs three types of files from the meta-data interpretation file creation process, alternate embodiments of the present invention could combine these different file types into one or two file types, or may output more than three file types, to suit the needs of the implementation.

### PREPARING DIGITAL IMAGE OUTPUT FILE

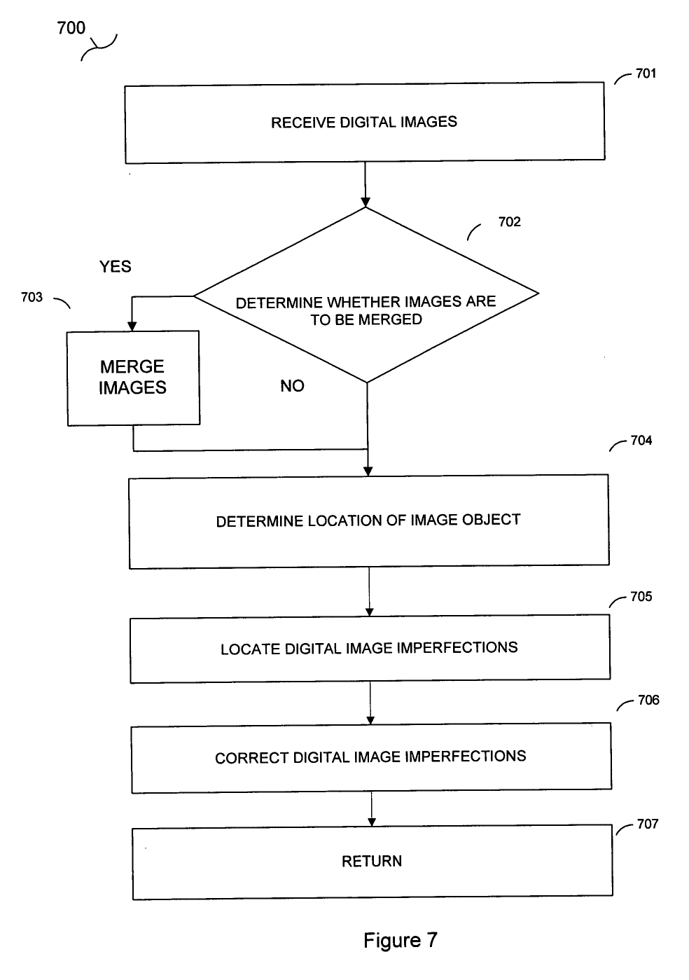

FIG. 7 is a generalized flow diagram illustrating the process of preparing the digital image files output from the reel scanner for viewing by a viewer. As discussed above in connection with FIGS. 5 and 6, the present invention creates a meta-data file which is associated with the images corresponding to a scanned roll image. This meta-data file includes information for the viewer to present and navigate among the digital images. Additionally, the present invention may prepare the digital images to correct defects or errors in the digital images, thereby improving the viewing experience, or may process the digital image files to improve the ability to extract information for preparing the digital image interpretation files. Process 700 illustrates some of the preferred defect correction and enhancement features of the present invention.

While one embodiment of the present invention could allow for improvement of the digital images (that is, defect correction or removal), to aid in viewing, or could specifically prevent improvement, as for example where preservation of exact images of roll film is desired. In embodiments which do not alter the digital images output for viewing, the digital images may be altered as part of the process of creating the image interpretation file (for example, to aid in the location of objects). Accordingly, process 700 may be adapted to provide information for the image interpretation file, without changing the digital files output and used by the digital reel viewer (in such an embodiment, copied, memory resident, or otherwise functionally equivalent files, may be processed including such steps as resizing, cropping, pixel removal, or the like, to aid in the location of an image object to provide information for the image interpretation file).

As described above, an image object may or may not be included in a given image file. When an operator uses a reel scanner to process a roll film the reel scanner may take images of section of the film which do not include an image object. Also, the reel scanner may also take digital images which have more than one image object. An example of this occurrence is when a digital image captures a portion of the next image object, as sometimes occurs when taking digital images of microfiche documents, such as county records or the like. The portion, or sliver, of the next image object may be unreadable in a given digital image, or may be readable when merged with a portion of the next digital image in the sequence.

At step 701 the system receives the digital images from step 503 of process 500. At step 702 the system checks to determine if the images are to be merged or partitioned. In the presently preferred embodiment, if several images are to be merged this will be specified in the settings. If at step 702 the system determined that images were to be merged (or partitioned) the system proceeds to step 703 where the merger (or partitioning) occurs. At step 703 the orientation and sequencing information from the settings is used in the merger (or partition) of the digital images. In the event the system determines there is no merger (or partitioning) of images, or after step 703, the system proceeds to step 704.

At step 704 the system locates the image object in the digital image. Typically, the image object is distinct from the background of the digital image. As a clarifying example: in the event of a records book recorded on microfiche, the page of the records book is much lighter color, near white, while the background is quite dark, typically near black. While the text on the page may appear black, and there may be imperfections in the background (from the imaging, from dirt or imperfections, or from scratches in the roll film). Despite this, the image object may be relatively easy to identify as a large (relative to text or imperfections) having a different color from the background. In the event the quality of the roll film is poor, or the scanner creates a low quality digital image, location of the image object may not be easy. In such a case, correcting for scratches, noise removal, inverting (positive to negative, or vice versa), fattening white pixels, looking only at certain regions of interest (e.g. the top 200 pixels, bottom 200 pixels), etc., may be performed. For example, in some poor quality roll film, only the top edge is distinctive of the page of a recoded book (i.e. the image object). In such an example, the present invention could look only at the top portion of the film, detecting the top edge of the page and then fixing the image object height from the top edge to correspond with the page recorded in the microfilm.

At step 704 the system identifies the specific location and size of the image object (for example, by specifying its pixels and dimensions of pixels from the edge of the digital image).

At step 705 the system locates digital image imperfections. Once the image object has been determined, the system may locate other objects, typically scratches and other defects which have been picked up and recorded by the reel scanner. As the size and shape of the image object are typically know (and may be specified in the settings to facilitate image and imperfection identification and location, for example by specifying a minimum image object size or dimension), it is relatively simple to detect imperfections, which show up as contrasting pixels in areas which are expected to be of another color (for example, small areas of light pixels typically represent a flaw in the digital image).

If image improvement and/or correction is desired, at step 706 the system corrects the defects identified and located in step 704. Defect correction/minimization may be as simple as inverting the color of the pixels identified with a digital image defect (e.g. from light to dark). Other options include cleaning and reducing noise (for example removing a white pixel when all the surrounding pixels are black), trim or remove pixels, fatten or add pixels, and merge image objects (which id different from merging two digital images, as the digital images are different files, while the image objects are areas of pixels within a digital image and are merged to create a single image object).

After completing step 706 the system returns to step 503 of process 500 at step 707.

### DIGITAL REEL VIEWER

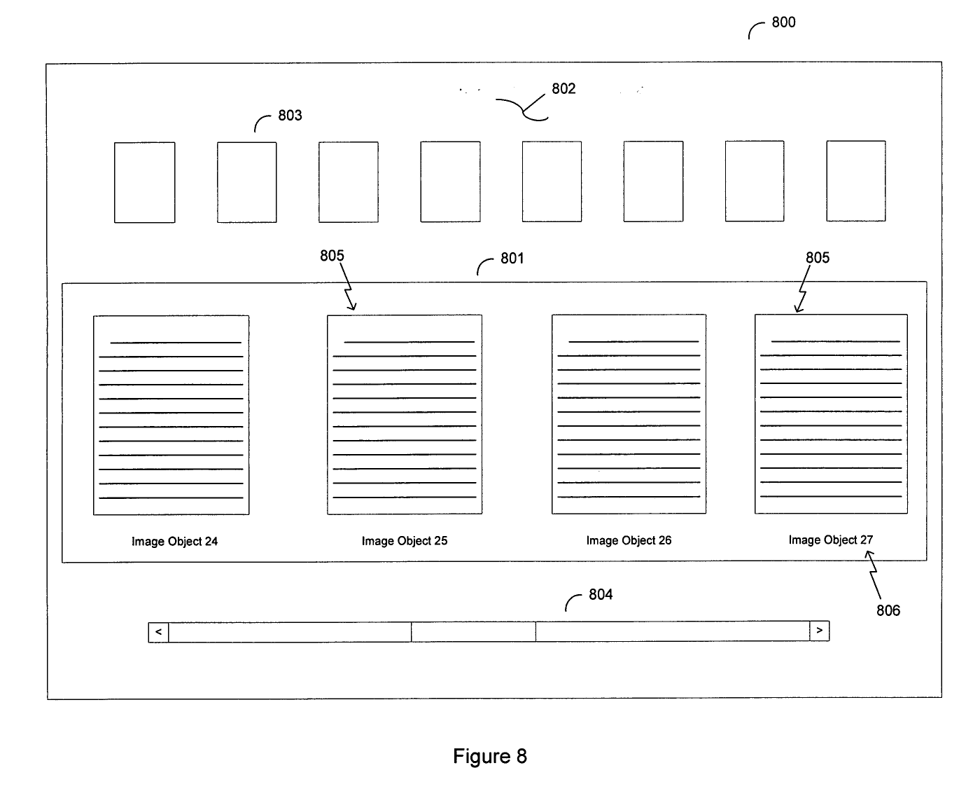

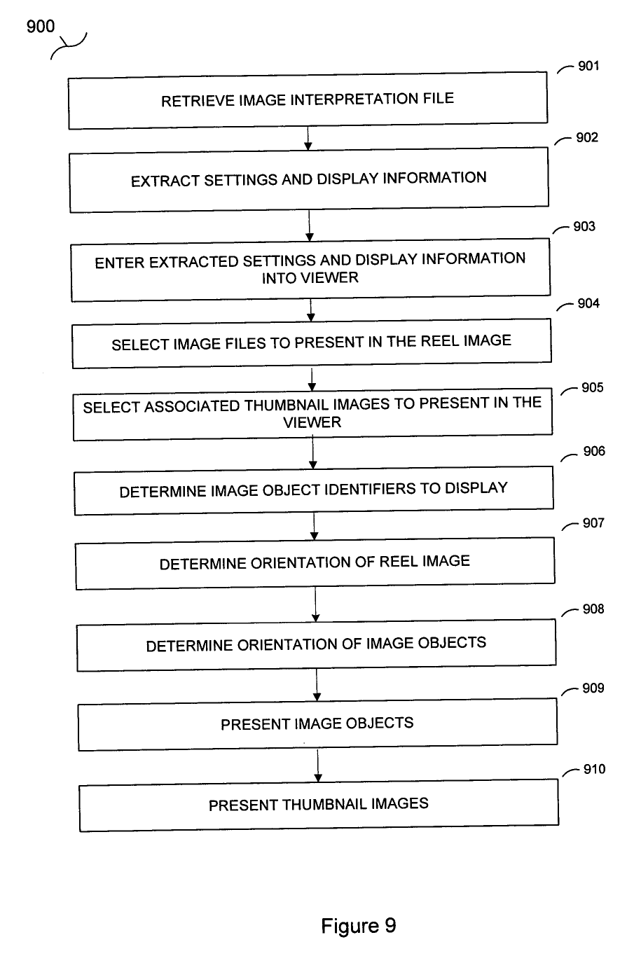

FIG. 8 is a generalized block diagram illustrating a digital reel viewer 800. As described below in connection with FIG. 9, the viewer receives digital image files and the meta-data digital image interpretation file, and optionally the thumbnail files, and presents the image objects. In the presently preferred embodiment, the input for the digital reel viewer is the files output from the image processor, illustrated in FIG. 6.

Referring to FIG. 8, the image viewer includes the reel image 801, thumbnail strip 802 including thumbnail images 803, and the scroll control 804. The scroll control is implemented in the example embodiment as a scroll bar, and allows a user to progress through the reel image in either a forward or reverse direction.

The reel image 801 represents the roll film associated with the digital images received by the viewer. As shown, reel image 801 includes multiple image objects 805. As presented by the viewer, the reel image presents these digital images, and the image objects contained in the digital images, in the form of a continuous (or near continuous) image. In this manner the reel image approximates scrolling through the roll image, to provide an end user with an experience similar to scrolling though an actual roll film with a viewer (for example, as when an end user uses a microfilm viewing station to view microfilm roll film).

Image object identifiers 806 are displayed in a manner associated with the image object displayed in the reel image. The image object identifiers provide text or graphical information which aids in identifying the associated image object. As shown, the image object identifiers are presented below the image objects. Alternative embodiments could present the image object identifiers in other locations associated with the image objects.

The thumbnail strip 802 is presented above the reel image 801 (alternate embodiments could present the thumbnail strip in other positions). The thumbnail strip presents thumbnail images associated with the image objects displayed in the reel image. Additionally, the thumbnail strip presents thumbnail images of image objects not presented within the “field of view” of the reel image. More particularly, thumbnail images corresponding to image objects in the sequence of image objects just “above” or “below” the image objects represented in the reel image (or to the “left” or “right” if the reel image is oriented in cinemode). In this manner, the thumbnails provide end users with information to allow them to scroll “up” or “down” the virtual roll film to find the image object, and the content information in the image object, they wish to view. In the presently preferred embodiment, the thumbnail images include 3 thumbnail images above and three thumbnail images below the image objects represented in the reel image. As the end user scrolls up or down the sequence of image objects the thumbnails displayed in the thumbnails strip scroll such to keep the thumbnail images corresponding to the image objects displayed in the reel image approximately centered in the thumbnail strip. In this manner the viewer continues to present thumbnails of the image objects just “above” or “below” the image objects represented in the reel image as the end user scrolls through the sequence of digital images, thereby continuing to provide navigation information just outside the “field of view” the reel image provides of the sequence of image objects representing a roll image.

In the presently preferred embodiment, the thumbnail images aid in navigation by allowing an end user to jump to the image object corresponding to the thumbnail image selected by the end user (preferably by clicking on the thumbnail image). Upon selecting a thumbnail image, the viewer displays the corresponding image object in the reel image. Additionally, the viewer displays the images objects closest (in the sequence of image objects) to the image object corresponding to the selected thumbnail image. The image objects, as described above, are displayed by displaying the image file containing the image object in the reel image of the viewer. Additionally, the viewer also changes the position of the thumbnail images in the thumbnail strip to maintain the approximate centering of the thumbnail strip to include the thumbnail images corresponding to the image objects displayed in the reel image. In this manner the viewer provides a dynamic scrolling, providing information on the image objects both “above” and “below” (or “forward” and “back”) in the sequence of image objects, thereby aiding the end user in scrolling to locate a given image object.

As shown in FIG. 8, the reel image is implemented as a horizontal display “window” where image objects are scrolled through and move either from right to left, or from left to right, according to the scroll inputs received through the scroll controls. Alternate embodiments, could have the reel image oriented in a vertical or diagonal direction, with image objects scrolling though in either

The embodiment shown in FIG. 8 includes the optional thumbnail images. Alternate embodiments could implement the other features of the present invention without the thumbnail or thumbnail strip shown above.

FIG. 9 is a generalized flow diagram illustrating the process 900 of presenting a reel image including image objects. At step 901 the viewer retrieves the image files and associated image interpretation file. In the presently preferred embodiment, the viewer allows the end user to look for and open digitized roll film that the end user is interested in viewing. Alternate embodiments could have the viewer display digitized roll film images sent to the viewer. The viewer allows the end user to select a digitized roll film image from a list of roll film images, by searching for files, or by typing in a specific identifier of a digitized roll film image. At step 901 the viewer may first retrieve the image interpretation file and use information stored in the image interpretation file to locate the associated image files, or the viewer may first retrieve the image files and then select an image interpretation file, either by knowing the unique identifier of the associated image interpretation file (for example, by a preset file namespace) or by retrieving information from image files as to the location or unique identifier of the associated image interpretation files, or by input from the end user or anther source (for example, web services).

At step 902 the viewer opens the image interpretation file associated with the image files and the roll film and extracts from the associated image interpretation file settings and display information. In the presently preferred embodiment, the image interpretation file is an XML file. Accordingly, the viewer retrieves the settings and display information from the XML file by parsing the file (aided by tags) to retrieve the settings and display configuration information.

At step 903 the viewer enters the extracted settings and display information as presentation settings in the viewer. The presentation settings of the viewer are used by the viewer to set up the layout of the viewer. The extracted settings and display information may specify the orientation of the digital images, the sequence of the digital images, digital image encoding, encryption or display information, the orientation of the image objects, image object identifying information, image content information, image object image file location information (which image file or files contain a given image object), or other information to present the image objects in the viewer.

At step 904 the viewer selects the image files to present in the reel image. The selected image files may correspond to the first image object in a sequence of image objects, a designated image object (say, corresponding to an index, contents page, title page, or other designated image object), or to a selected image object. In the presently preferred embodiment, the viewer decrypts the image files when it first accesses the image files, and stores decrypted copies of the image files in a cache, which is destroyed when the viewer is closed or the user logs off. If the image interpretation file and/or thumbnails are encrypted, the same decryption process and caching is preferably used. Alternate embodiments may decrypt at other stages of the viewing process, or not use encryption at all.

A given image file may correspond to any number of image objects. One image object may be contained on multiple image files. An image file may contain one, or multiple, image objects. The viewer supports these variations by including information in the image interpretation file which may specify the number of image objects in a given image file, the number of image files an image object is contained in, and other information to aid in presenting and navigating the image objects.

For illustration purposes, unless otherwise noted, the present application will assume at least some of the image files contain multiple image objects and that it is possible that a given image object is divided between two (or more) image files.

At step 905 the viewer selects the thumbnail images associated with the image files selected for presentation in the reel image at step 904 (if there are thumbnail images, or if the embodiment implements thumbnail images). As stated above, the preferred embodiment has a wider range of display for thumbnail images than is done for image objects (due to side constraints). The preferred embodiment maintains centering of the thumbnail images with the image object displayed in the reel image. This, if the reel image displayed At step 906 the viewer determines the image object identifiers to display, and correlates the image object identifiers with the image objects for display in the reel image.

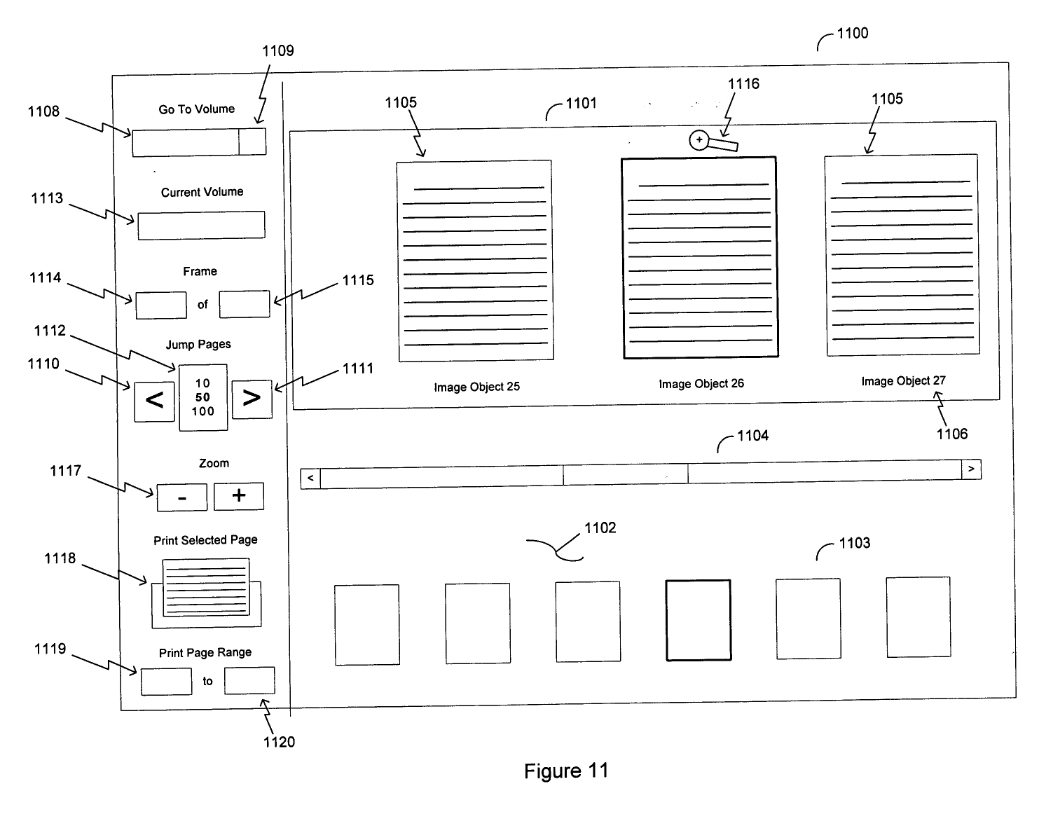

In one possible embodiment the digital reel image viewer determines the orientation of the reel image at step 907. The present invention allows presentation of the reel image in a horizontal (image objects positioned side by side as shown in FIGS. 8 and 11) or vertical manner (image objects positioned above one another). Also, the reel image may scroll image objects in left to right ascending, right to left ascending, top to bottom ascending, or bottom to top ascending. If the embodiment of the viewer supports these alterative display modes the viewer determines the proper display mode for the reel image at step 907. In the presently preferred embodiment, this orientation is based upon the original orientation of the scanned roll film.

At step 908 the digital reel viewer determines the orientation of image objects. A given image file may contain an image object oriented in any of a given number of positions. To facilitate navigation and legibility, the digital reel viewer presents the image objects oriented in a top to bottom orientation (that is, if the image object is a page from a record book the text is right side up and read left to right and top to bottom in the English language). This prevents end-users from having to read text on a document that appears rotated “on its side” or “upside down.”

At step 909 the digital reel image viewer presents the image objects and corresponding information according to the settings and display information. In the presently preferred embodiment, presentation of the image objects is accomplished by presenting the selected image file, or a portion of the image file, in the reel image area of the digital reel viewer. If two more image files are selected for presentation, the viewer orders the image files according to the ordering of the image objects.

At step 910 the digital reel image viewer presents the thumbnail images and corresponding information according to the settings and display information.

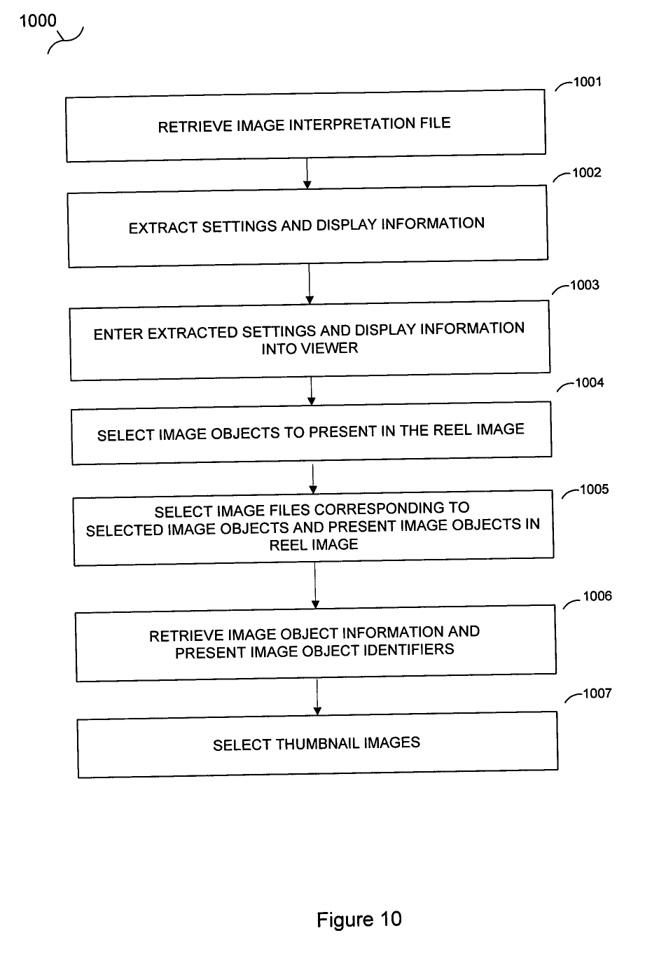

FIG. 10 is a generalized flow diagram illustrating an alternate embodiment of the process 1000 presenting a reel image including image objects. At step 1001 the viewer retrieves the image files and associated image interpretation file. At step 1002 the viewer opens the image interpretation file associated with the image files and the roll film and extracts from the associated image interpretation file settings and display information. At step 1003 the viewer enters the extracted settings and display information as presentation settings in the viewer.

At step 1004 the viewer selects the image objects to present in the reel image. At step 1005 the viewer selects and processes the image files corresponding to the selected image objects and presents the selected image objects in the reel image.

At step 1006 the viewer retrieves image object information corresponding to the selected image objects and presents it in the image object identifiers.

If the viewer implements thumbnail images, or if the settings specify providing thumbnail images, at step 1007 the viewer selects the thumbnail images to present. Preferably, the thumbnail images correspond to the image objects selected for display in the reel image.

At step 1008 the viewer presents the thumbnail images selected at step 1007.

FIG. 11 is a generalized block diagram illustrating an alternate embodiment of a digital reel viewer illustrating several navigation, selection, zoom and print controls which may be included together or in combination in various embodiments of the present invention. As with the viewer shown in FIG. 8, the digital reel viewer 1100 includes the reel image 1101, thumbnail strip 1102 including thumbnail images 1103, and a scroll control 1104. The scroll control is implemented in the example embodiment as a scroll bar, and allows a user to progress through the reel image in either a forward or reverse direction. The reel image 1101 includes multiple image objects 1105. Image object identifiers 1106 are displayed in a manner associated with the image object displayed in the reel image.

The viewer 1100 also includes a volume jump control including a volume jump entry field 1108 and a execute jump, or “go to,” button 1109, a jump forward button 1110, ajump back button 1111, and a jump setting selector 1112. Often, documents recorded on microfilm are indexed by volume numbers. These volume numbers may be included with the image interpretation file and used by the viewer to both display information on the image object as well as navigate to the desired image object. By entering the desired volume identifier (typically a number) in the volume jump entry field and clicking on the go to button (or hitting enter) the viewer “jumps” to the entered volume, displaying the first image objects corresponding to the entered volume (or the post appropriate image objects, if the first image objects are not preferred).

The jump forward button 1110 and jump back button 1111 allow an end user to jump forward or backward though the digital reel, thus allowing the viewer to jump ahead a preset number of image objects, thereby avoiding the need to scroll through the digital reel to get to a given image object. The jump setting selector 1112 both indicates the settings for the jump forward button 1110 and jump back button 1111. As shown, the jump setting selector has settings for 10, 50 and 100 (alternate embodiments could be implemented with any preset, or enterable, settings, including having more than or less than three preset settings to select). The selected setting is indicated by a highlighting, or presenting the selected setting in a different color, or by other graphical indication. If, for example, the jump selector is set for 50 and indicated (as shown), then and end user selecting the jump forward button results in the digital reel viewer jumping forward by 50 image objects. As the end user is searching for a given image object, as they come closer to the given image object the end user may jump forward in smaller increments by selecting the lower valued jump settings using the jump settings selector.

To aid the end-user in navigating the digital roll film, the embodiment also includes a current image object identifier which includes a current volume display 1113 and a current frame display. The current frame range display includes a start frame range display 1114 and an end frame range display 1115. When the digital reel viewer jumps to a new frame, or image object, the fields of the current image object identifier are updated to reflect the new frame.

In the presently preferred embodiment, the viewer also “jumps” to the thumbnail images corresponding to the image objects displayed in the image reel, and which correspond to the volume information entered in the volume jump entry field. The corresponding thumbnail images jumped to are displayed in the thumbnail strip of the digital reel viewer.

The digital reel viewer 1100 allows the end user to select a given image object. A pointer associated with an I/O device of the end-user communication devices 105 (described above in connection with FIG. 1) running the digital reel viewer, such as a mouse or keyboard, allows the end user to select an image object, and/or change which image object is selected, and/or allow a group of image objects to be selected. In the presently preferred embodiment, the selected image object is highlighted by a border surrounding the selected image object (as shown by the bold of the border on the center image object shown in the reel image) to indicate its selection. Additionally, the thumbnail image corresponding to the selected image object is also indicated (also as shown by bold border of the thumbnail image). The present invention allows the end-user to select a thumbnail image, which the viewer will indicate as described, and accordingly the viewer will also indicate the image object in the reel image corresponding to the selected thumbnail image by indicating the corresponding image object as described. While the preferred embodiment utilizes highlighted borders to indicate selection of image objects and thumbnail images, alternate embodiments could use other graphical representations to provide visual indication of the selection.

The image viewer 1100 also allows the end user to zoom in or out to examine image objects. As shown in this example embodiment, the zoom controls are implemented by the mouse pointer 1116 which indicates whether it is set to zoom in, or zoom out. An end user may change the setting of the mouse pointer (for example, by double clicking and bringing up a change settings dialog box). Additionally, (or alternatively) the present embodiment includes zoom controls 1117 which include a zoom in button and a zoom out button for controlling the view of the selected image object.

The image viewer 1100 also includes a print image object control. The print image object includes, in the presently preferred embodiment, a print selected image object 1118 and print range of image object sector, which includes a begin print range entry field 1119 and an end print range entry field 1120.

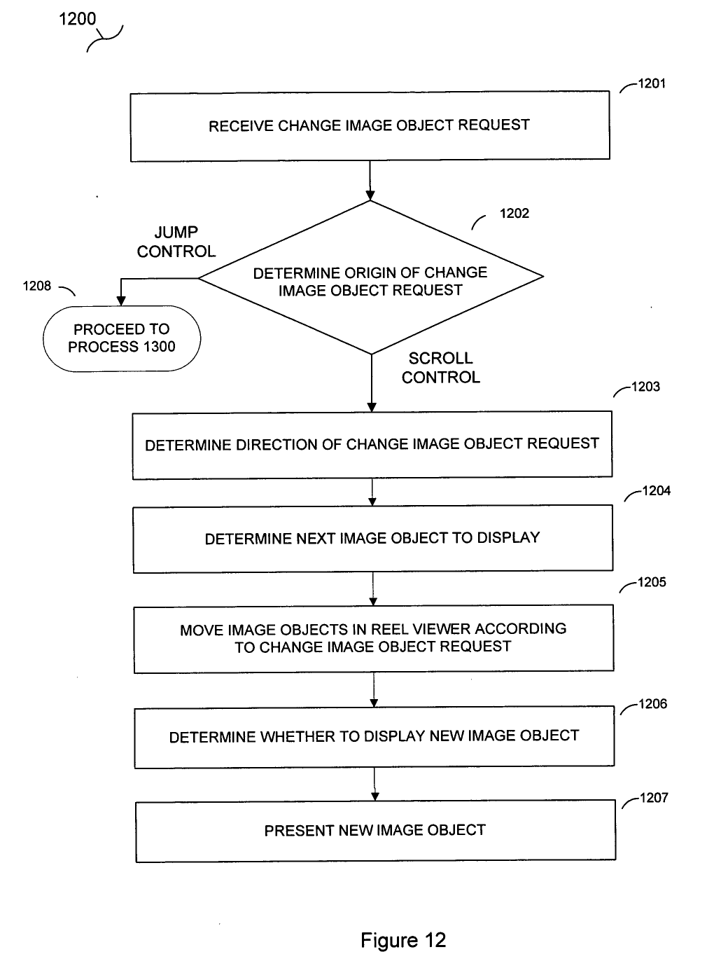

FIG. 12 is a generalized flow diagram illustrating the process 1200 of navigating and presenting image objects by a viewer as exemplified by the embodiment shown in FIG. 11. As described above, navigation of the image objects can be performed in several ways. The end-user may scroll through the images using the scroll control, they may use the jump control to either jump to a particular image object or jump forward by a preset number of image objects.

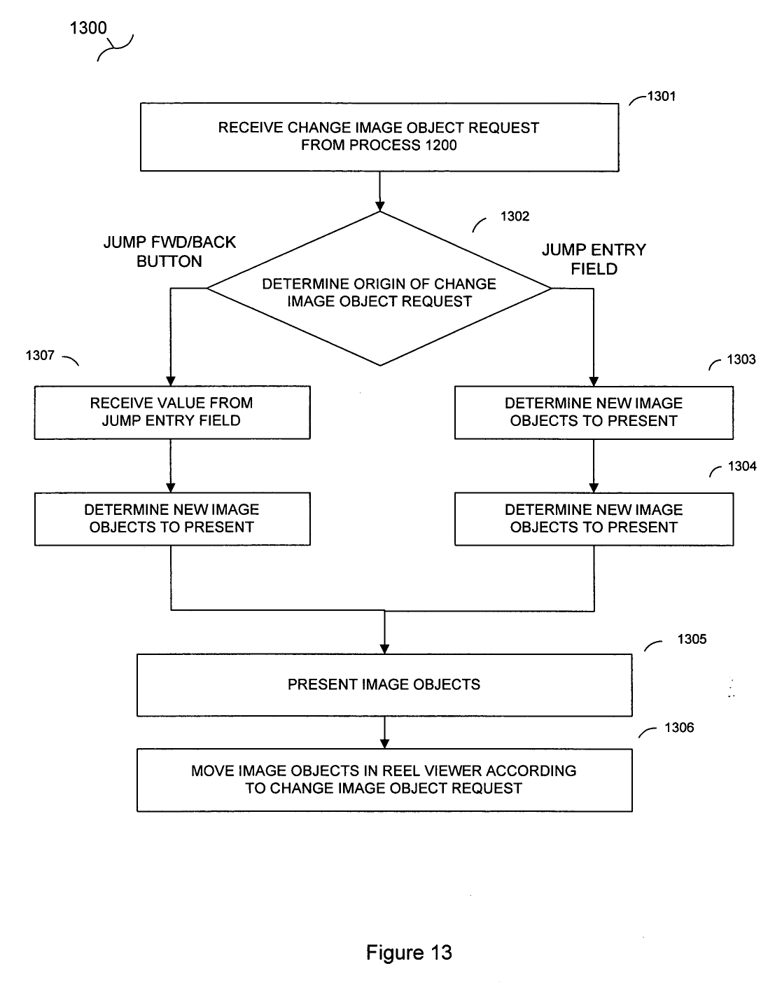

At step 1201 the viewer receives a change image object request. The change image object request can be from either a scroll control or from the jump control. At step 1202 the viewer determines which control request originated the change image object request. If at step 1202 the viewer determines the change image object request originated from the scroll control, the viewer proceeds to step 1203. If at step 1202 the viewer determines the change image object request came from the jump control, the viewer proceeds to step 1208. At step 1208 the viewer proceeds to process 1300 described below in connection with FIG. 13.

At step 1203 the viewer determines the direction of the change image object request and moves the image objects displayed in the direction indicated in the change image object request. As stated above, one image file may include several image objects. In such an embodiment, the viewer moves the image objects by moving the image object file displayed in the reel image.

At step 1204 the viewer determines the next image object to be displayed as the scroll moves in the indicated direction determined in step 1203 (or determines the next image file necessary to complete an image object—when the image object is contained in more than one image file—and movement in accordance with the change image object request indicates the portion of the image object contained in another image object is to be displayed). The viewer retrieves sequence information obtained from the image interpretation file and, based upon the retrieved sequence information, determines the next image object in the sequence. From the image interpretation file, the viewer also determines whether the next image object is included in the currently displayed image file, or whether the next image object (or a portion of the next image object) is in a different image file from the image file currently being displayed. If the next image object for display is, either partially or fully, contained in a different image file, the viewer determines the image file containing the next image object from the image interpretation file. The next image object in the sequence is then set as the next image object for display in the reel image.

At step 1205 the viewer moves the image objects in accordance with the direction of change determined in step 1203.

At step 1206 the viewer determines whether the movement at step 1205 is sufficient to include a new image object. If the determination is made that the movement is sufficient to present a new image object in the reel image, the viewer proceeds to step 1207 and presents the image object determined at step 1204. The viewer determines at step 1206 the positioning and portion of the image object to present (for example, the scrolling may not have been sufficient to show the entire new image object, so the viewer will only show a portion of the image object, in accordance with the change image object request). Additionally, at step 1206 the viewer determines whether the movement is sufficient to remove an image object from the reel image. If the determination is made that the movement is sufficient to remove a presently displayed image object from the reel image, the viewer proceeds to step 1207 and removes the appropriate presently displayed image object in accordance with the direction of the movement as indicated in the change image object request. In determining whether to include a new image object or remove an image object displayed in the reel image, the viewer determines the image file to display in the reel image. The viewer retrieves information from the image interpretation file which specifies the image file to be retrieved and displayed. Additionally, the viewer determines whether, based on the image objects being displayed or to be displayed according to the movement, the image file or files displayed in the reel image should be removed.

After step 1206 the viewer returns to step 1201. As an end user may continue scrolling, the viewer continues to receive change image object instructions, and continues to move, remove, and present image objects in accordance with the change image object instructions.

FIG. 13 is a generalized flow diagram illustrating the process 1300 of responding to change image object instructions from the jump controls of the viewer.

At step 1301 the viewer receives the change image object instructions from step 1207 of process 1200 described above. At step 1302 the viewer determines whether the change image object request originated from the jump entry field or from either the jump forward button or jump back button.

If at step 1302 the viewer determines the change image object request originated from the jump entry field the viewer proceeds to step 1303.

At step 1303 the viewer retrieves the value entered in the jump entry field (which in the example embodiment corresponds to a volume).

Based upon the value entered in the jump entry field, the viewer determines the appropriate image objects to present in the reel image at step 1304. This determination is made from the sequence information obtained from the image interpretation file. For example, if the viewer received a change image object request to jump to image object 128, the viewer would retrieve information from the image interpretation file and determine the corresponding image objects in the sequence to display with image 128 in the reel image of the viewer. In this example, three image objects are currently displayed in the reel image, and these image objects correspond to image objects 24, 25, and 26 in the sequence (which may be measured from the beginning of the roll film, from the beginning of a “book” or volume, or some other marker). Image object 128 was received as the image object to display form the jump control. In the present example, the viewer displays the image object corresponding to the value entered in the jump entry field in the center (or nearly in the center) of the reel image, and displays the neighboring image objects in the sequence of image objects in the reel image along with the selected image object. In the present example with three image objects displayed in the reel image, the corresponding image objects in the sequence, neighboring image object 128, would be image objects 127 and 129. Accordingly, at step 1303 the viewer determines that image objects 127, 128 and 129 are to be displayed next in the reel image, in the appropriate sequence order.

At step 1305 the viewer presents the image objects determined at step 1304 or step 1307. As a given image object may be divided between two image files, or one image file may include more than one image object, the viewer utilizes the information from the image interpretation file to select the appropriate image files, merge or crop the image files and present the appropriate image objects.

If at step 1302 the viewer determines the change image object request originated from the jump forward button or jump back button the viewer proceeds to step 1307.

At step 1307 the viewer retrieves the value entered in the jump entry field (which in the example embodiment corresponds to a volume). Based upon the jump setting and the jump direction button selected (either the jump forward button or the jump back button), the viewer determines the appropriate image objects to present in the reel image at step 1308. This determination is made from the sequence information obtained from the image interpretation file. For example, if the viewer received a change image object request to jump fifty (50) image objects, the viewer would determine, based on the image objects displayed in the reel image, what image objects correspond to fifty image objects further along in the sequence. If, in this example, three image objects are currently displayed in the reel image, and these image objects correspond to image objects 24, 25, and 26 in the sequence (which may be measured from the beginning of the roll film, from the beginning of a “book” or volume, or some other marker), the viewer would select image objects fifty forward in the sequence. In this example, image objects 74, 75 and 76 would be selected as the appropriate image objects for display based upon the received change image object request received from the jump control.

At step 1305 the viewer presents the image objects determined at step 1308. As a given image object may be divided between two image files, or one image file may include more than one image object, the viewer utilizes the information from the image interpretation file to select the appropriate image files, merge or crop the image files and present the appropriate image objects.

After presenting the image objects at step 1305, at step 1306 the viewer returns to step 1201 of process 1200 and awaits further input.

### CREATING, SAVING AND USING BOOKMARKS

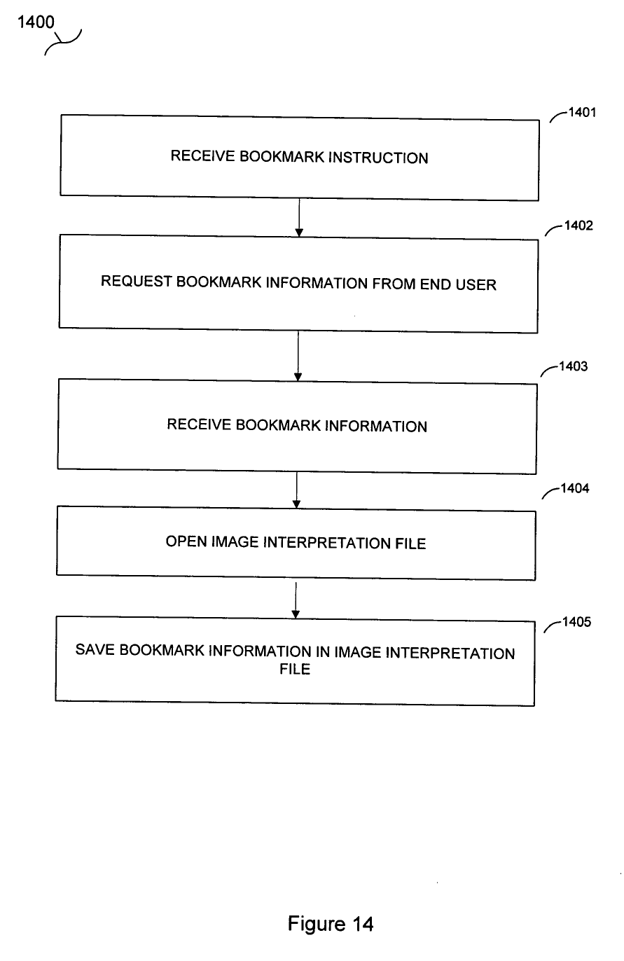

FIG. 14 is a generalized flow diagram illustrating the process 1400 of establishing bookmarks in the digitized roll film. As a user may wish to add a bookmark to a given digitized roll film to indicate information, or make returning to that given portion of the digitized roll film, the present invention provides the ability to add a bookmark to the digitized roll image to aid in future viewing and navigation.

In the presently preferred embodiment, the ability to add bookmarks is limited to authorized users only, for example an administrator who could only access the bookmark functionality with a secure login (or has access to a restricted access workstation with bookmarking capability). Alternate embodiments may allow greater or even universal access for bookmarking.

At step 1401 the viewer receives an instruction to bookmark a given image object or image objects (according to whether one or multiple image objects have been selected). At step 1402 viewer prompts the end user to enter information concerning the bookmark. The information may include a description of the document, name of the document, or may indicted an aspect of the document, such as a begin document, begin chapter, end document, end chapter, or other demarcations of sections of a document. At step 1403 the viewer receives bookmark information entered by the end user.

At step 1404 the viewer opens the image interpretation file. At step 1405 the viewer saves the bookmark information in the image interpretation file. In the presently preferred embodiment, the viewer includes bookmark information in the image interpretation file, which the viewer may then use to present bookmark information when the digitized roll film is viewed in the future. Alternate embodiments of the present invention may store bookmark information in a separate file from the image interpretation file.

While the present invention allows for users to add there own bookmarks, the present invention also allows pre-existing markers on the roll film to be used in navigation of the digital roll film. Markers can be as simple as blocks of light or dark (or a given size or different sizes indicating different aspects of the document), or may be more complex such as a symbol or code. Some roll film include markers which identify the start of a book, volume or other document type, or indicate the end or other places of interest in a document or series of documents. During creation of the image interpretation file, described above, these markers may be detected by the image processor and the information encoded may be included in the image interpretation file and used by the digital image viewer. The viewer may display information from the markers, for example in the image object identifiers or elsewhere in the viewer, or may use the information in selecting the appropriate image file and associated image object during navigation.

The present invention provides a process of creating digital image files which include the meta-data to allow the digital images to be viewed in sequence, with the correct orientation, thereby providing the end user with the ability to view the digital images in much the same manner as they would view the original roll film, without the disadvantages associated with roll film. The present invention provides meta-data information which aid in the navigation of the digitized roll film and in the location of object images.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

We claim:

1. A method and system of presenting digital images, comprising:
retrieving an image interpretation file, the image interpretation file including presentation settings;
extracting image presentation settings from said image interpretation file;
determining the orientation of image objects located in image files from said extracted presentation settings; and
presenting at least one image object in a reel image of a viewer according to the orientation determined from the extracted presentation settings.

2. The method of claim 1, wherein the determined orientation specifies the orientation of the reel image of a viewer.

3. The method of claim 2, wherein the determined orientation specifies a cinemode orientation of the reel image.

4. The method of claim 1, wherein the presented at least one image object is selected according to image object information extracted from said image interpretation file.

5. The method of claim 4, wherein the image presented at least one image object corresponds to image object identification information entered into the viewer, and wherein the viewer selects the presented at least one image object according to the entered image object identification information and sequence information of the image object, wherein the sequence information from the image object is retrieved from the associated image interpretation file.

6. A method of presenting digital images of a roll film, comprising:
receiving an image interpretation file, the image interpretation file corresponding to a plurality of image files, the image files including image objects taken from scanning a roll film image using a digital scanner;
retrieving the one or more image files corresponding to a roll film;
retrieving presentation settings from the image interpretation file; and
presenting the one or more image files in a reel image of a viewer in accordance with the retrieved presentation settings.

7. The method of claim 6, wherein the presentation settings specify the orientation of the reel image.

8. The method of claim 6, wherein at least one image file contains multiple image objects.

9. The method of claim 6, further comprising:
in response to an image change object request,
determining whether a new image object is to be presented in the reel image;
if the determination is to present a new image object, selecting an image file according to sequence information retrieved from the image interpretation file; and
presenting the selected second image file including at least one image object in the reel image of the viewer.

10. The method of claim 9, further comprising
selecting a plurality of thumbnail corresponding to the image objects displayed in the reel image;
retrieving a plurality of thumbnail images corresponding to the image objects of the retrieved image files; and wherein the change image object request was received
presenting the selected thumbnail images in a thumbnail strip of the viewer.

11. The method of claim 9, wherein the change image object request was received from movement of the scroll bar of the viewer.

12. The method of claim 10, further comprising:
in response to the change image object request;
determining whether a new thumbnail image s to be displayed, is said determination is to display a new thumbnail image;
selecting a thumbnail image according to sequence information retrieved from the image interpretation file; and
presenting said selected thumbnail image in the viewer.

13. The method of claim 6, further comprising:
in response to an image change object request,
determining whether the image object was received from a jump entry field of a viewer;
in the event the change image object request was received form a jump entry field of a viewer;
selecting an image object to present according to a value entered in the jump entry field;
selecting a corresponding image file containing the selected image object, wherein the corresponding image file is selected using information retrieved from the image interpretation file; and
presenting the selected image object and corresponding image file in the reel image of the viewer.

14. The method of claim 13, further comprising:
in response to an image change object request received from a jump entry field of a viewer,
selecting at least one thumbnail image using information retrieved from the image interpretation file; and
presenting the selected at least one thumbnail image in the viewer, wherein at least one of the selected at least one thumbnail images corresponds to the selected image object.

15. The method of claim 14, wherein a plurality of thumbnail images are selected and presented in the viewer, and wherein the plurality of selected images correspond to a segment of the sequence of image objects and are presented in sequence within the viewer.

16. The method of claim 13, further comprising:
in response to a selection instruction received from the viewer selecting an image object displayed in the reel image of a viewer,
providing a visual indication of the selected image object.

17. The method of claim 16, further comprising:
in response to a selection instruction received from the viewer selecting an image object displayed in the reel image of a viewer,
providing a visual indication of the thumbnail image corresponding to the selected image object.

18. The method of claim 17, further comprising:
in response to a selection instruction received from the viewer selecting an image object displayed in the reel image of a viewer,
providing a visual indication of the selected image object.

19. The method of claim 17, further comprising:
in response to a print instruction received from the viewer,
printing the selected image object by:
retrieving image object information from the image interpretation file,
selecting the image file or image files corresponding to the selected image object,
cropping and/or merging the selected image files corresponding to the selected image object to provide a printable image object, and
printing the selected image object.

20. The method of claim 14, further comprising:
in response to a bookmark instruction received from the viewer,
adding bookmark information to the image interpretation file.
